(19) United States
(12) Patent Application Publication
(10) Pub. No.: US 2013/0093758 A1
(43) Pub. Date: Apr. 18, 2013

(54) METHOD AND APPARATUS FOR MEASURING AND DISPLAYING OR REPORTING A SELLER'S PERFORMANCE

(71) Applicant: Noel Lee, Las Vegas, NV (US)

(72) Inventor: Noel Lee, Las Vegas, NV (US)

(21) Appl. No.: 13/592,216

(22) Filed: Aug. 22, 2012

Related U.S. Application Data
(63) Continuation-in-part of application No. 12/332,225, filed on Dec. 10, 2008, now abandoned.
(60) Provisional application No. 61/013,582, filed on Dec. 13, 2007.

(51) Int. Cl. G06T 17/10

(52) U.S. Cl. CPC G06Q 10/06398; G06T 17/10
USPC 345/419

(57) ABSTRACT

A method and apparatus for measuring and displaying or reporting a seller's performance in the sale of accessory goods comprising determining the attachment rate of the goods, determining the average selling price of the goods, and determining the items per transaction and using these values to generate a box-like three-dimensional figure representing the seller's performance.

### CROSS-REFERENCE TO RELATED DOCUMENTS

This non-provisional application is based on and is a continuation-in-part of U.S. Utility Application Ser. No. 12/332,225 filed Dec. 10, 2008. This application is also based on and claims priority to United States Provisional Application Ser. No. 61/013,582 filed Dec. 13, 2007. The disclosures of the aforementioned applications are included by reference as fully set forth herein.

### TECHNICAL FIELD

This invention relates to the field of performance evaluation, and more specifically to evaluation of a seller of accessory goods via an easy to understand cube-like performance matrix.

### BACKGROUND ART

Sales of accessory products differ from the sales other products in that the sale of an accessory product is typically “attached” to the sale of another primary product. Salespersons tend to suggest accessory products to a customer when that customer purchases a primary product. Customers may at times seek to purchase only an accessory product, but by and large the key opportunity for immediate sale of an accessory product occurs when a customer purchases a primary product for which an accessory product is designed or otherwise relevant.

Certain product markets, such as the home theater product market, are especially conducive to the sale of accessory products. A customer may seek out a retailer in order to purchase a home theater item such as a flat-screen television or an audio system. However, in order to fully install and enjoy such a product, several accessory products such as cables, power surge protectors or mounting devices may be required as well. Thus, at the time of sale there exists an important opportunity for the retailer to also sell accessory products.

As with any product, the goal of the seller of accessory products is to maximize sales. This is accomplished through gathering of relevant data, analysis, and targeted improvement measures. However, traditional notions of sales volume and revenue as performance indicators, even when analyzed in sophisticated ways, such as by personnel or as a function of time, do not adequately take account of the unique nature of accessory products.

Therefore, what is needed is a system and method for measuring and improving sales performance of accessory products. Such a system and method would take account of the attachable nature of accessory products, and the price variation amongst those products. It would also provide a single indicator allowing one to gauge overall sales performance at a glance.

### DISCLOSURE OF THE INVENTION

A system and method for measuring, displaying or reporting, and improving the sales performance of accessory products is disclosed. According to the present invention, three metrics are calculated: attachment rate, average selling price, and items per ticket. These three metrics are multiplied together to yield an overall performance score. The overall performance score can be visualized on a three-dimensional graph as a cube-like structure having the dimensions of each metric.

The overall performance score provides a single number that can be used to measure and compare different sellers' performance. It can also be broken down into its component metrics, thereby providing drill-down capabilities for detailed analysis and comparison. As a result, performance improvement measures can be targeted to address the lowest performance areas.

### BRIEF DESCRIPTION OF THE DRAWINGS

FIG. 1 is a flowchart in accordance with an embodiment of the present invention.

FIG. 2 is a flowchart illustrating a method of calculating step 20 of FIG. 1 in accordance with the present invention.

FIG. 3 is a flowchart illustrating a method of calculating step 30 of FIG. 1 in accordance with the present invention.

FIG. 4 is a flowchart illustrating a method of calculating step 40 in accordance with the present invention.

FIG. 5 is a three-dimensional graph illustrating the principles of the present invention.

FIG. 6 is a second three-dimensional graph illustrating the principles of the present invention.

FIG. 7 is a third three-dimensional graph illustrating the principles of the present invention.

FIG. 8 is a two-dimensional graph in accordance with the principles of the present invention.

FIG. 9 is a flowchart illustrating the reporting process in accordance with the principles of the present invention.

FIG. 10 is a flowchart illustrating the charting process in accordance with the principles of the present invention.

### BEST MODES FOR CARRYING OUT THE INVENTION

The present invention relates to a system and method for measuring and improving the sales performance of accessory products. At the outset, it is helpful to note that the use of terms such as “accessory products” or “all accessory products” may be appropriately limited depending on the application of the present invention. For example, if the present invention is to be applied to the measurement and improvement of a single manufacturer's sales, then the “accessory products” considered will be limited to accessory products made available for sale from that particular manufacturer. Likewise, if the present invention is applied to improve accessory sales of a particular store independent of its suppliers, then the accessory products may include all accessory products sold in the store, regardless of manufacturer.

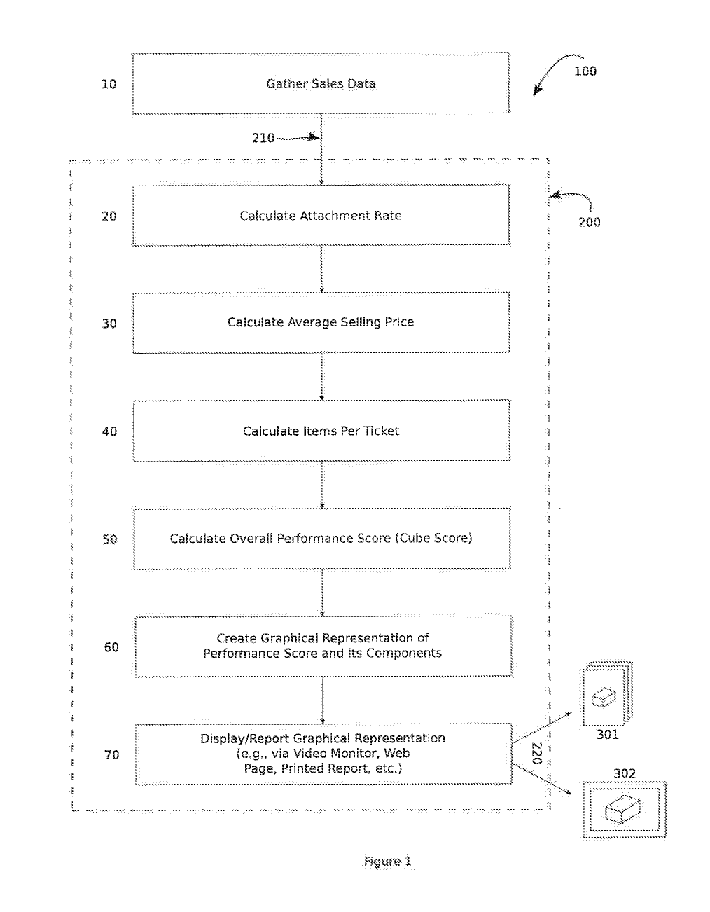

With reference to the flowchart illustrated in FIG. 1, and in accordance with an embodiment of the present invention, a method 100 of measuring sales performance via a series of calculations is disclosed. At step 10, appropriate sales data are gathered. Then, a series of three metrics is calculated: attachment rate, average selling price, and items per ticket. The sales data gathered in step 10 are input into a computing apparatus 200 via an input 210. The computing apparatus 200 is configured to perform steps 20 through 70. The computing apparatus 200 could be a single computer or network of a plurality of computers. The input 210 could be manual, or it could be configured to automatically download from a network, measure from sensors, or otherwise acquire sales data from step 10 on a periodic basis (e.g., daily, weekly, monthly, etc).

In step 20, the attachment rate is calculated. The attachment rate is the proportion of qualifying sales transactions in which at least one accessory product was sold in the same transaction. A qualifying sales transaction is a. sales transaction in which a primary product was sold, for which a relevant accessory product could have been “attached” or sold in conjunction.

In step 30, the average selling price is calculated. The average selling price is the average of the retail price of all accessory products sold.

In step 40, the number of items per ticket is calculated. Items per ticket is the average number of accessory products sold in a transaction in which at least one accessory product was sold with a primary product.

In step 50, the overall performance score is calculated. The overall performance score is calculated by multiplying together the attachment rate, average selling price, and items per ticket.

In step 60, the data calculated in steps 20-50 are used to create a graphical representation of the overall performance score and its components (attachment rate, average selling price, number of items per ticket).

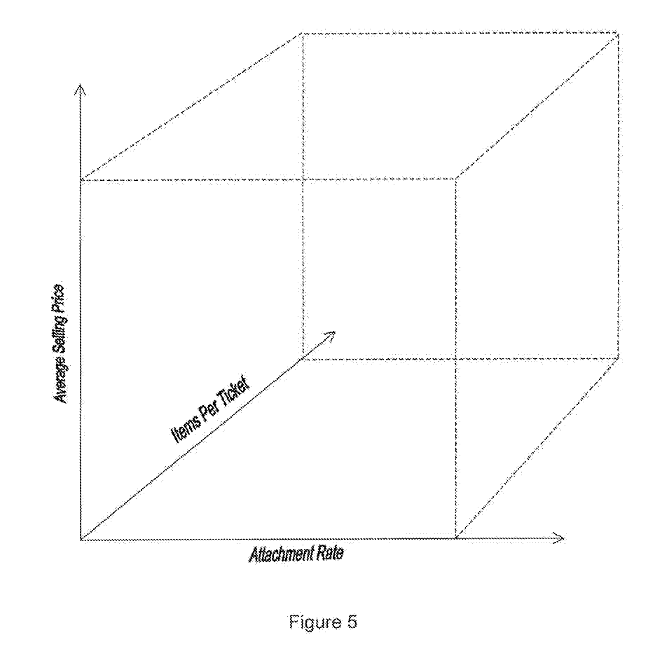

In step 70, the graphical representation is output via one or more outputs 220. The outputs 220 could include one or more display means 302 or one or more reporting means 301 for displaying or reporting, respectively, the graphical representation and calculations to a user (see also FIGS. 5-10). The display means could include (but in no way is limited to): depicting the graphical representation on a video device (such as a television, mobile phone, tablet, or computer monitor, or other 2D or 3D viewing device); embedding or linking to a static or interactive version of the graphical representation in a web page or e-mail; etc. The reporting means could include (but in no way is limited to): generating a physical or electronic document comprising the graphical representation which is printed, delivered, e-mailed, or transmitted by computer network to the user; publishing a web page or electronic document comprising the graphical representation via a URL, which is then transmitted to a user via e-mail, computer network, mobile storage device, etc.; even using a 3D plotter to render a physical representation; etc.

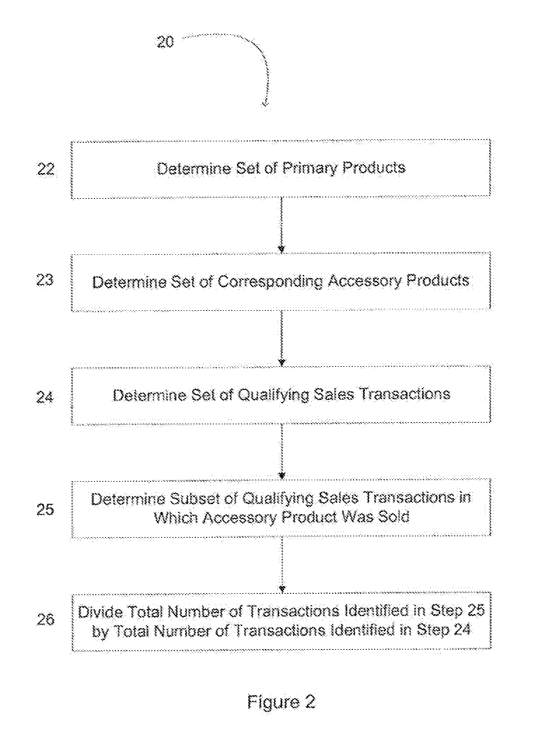

To more clearly illustrate the present invention, methods of calculating the above metrics are presented in FIGS. 2-4.

In FIG. 2, the method of calculating attachment rate, step 20 of FIG. 1, is shown. At step 22, a set of primary products is identified. This is based on the product inventory of the particular seller, and may be appropriately limited as desired (e.g. only home theater products). At step 23, a set of accessory products corresponding to each primary product is identified. This is also based on product inventory and may be appropriately limited in scope. At step 24, the set of qualifying sales transactions is determined by identifying those sales transactions in which at least one primary product was sold. By limiting the number of qualifying sales transactions as such, the metrics of the present invention are therefore tailored to those instances when a seller has a genuine opportunity to sell an accessory product. At step 25, the subset of qualifying sales transactions in which a qualifying accessory product was also sold is determined. At step 26, the attachment rate is calculated by dividing the total number of transactions identified in step 25 by the total number of transactions identified in step 24. The attachment rate metric is useful for gauging at a baseline level whether a seller is generally successful in adding accessory items to sales transactions.

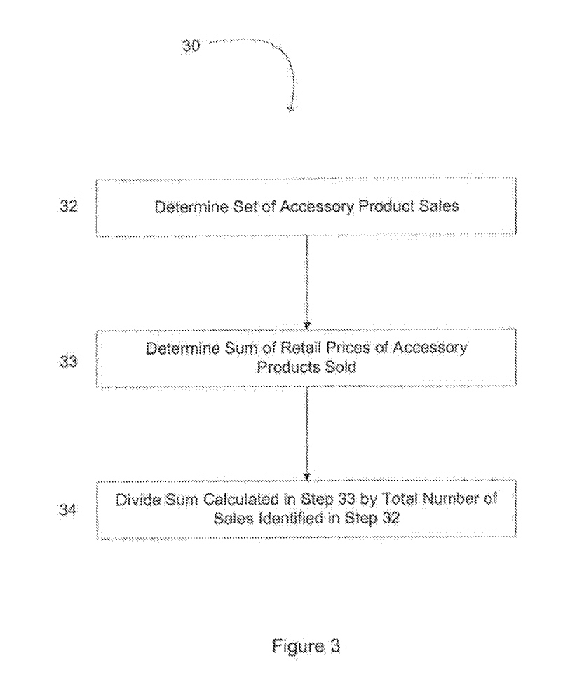

Details of step 30 of FIG. 1, calculating average selling price, are shown in FIG. 3. At step 32, the set of all accessory product sales for a given seller is determined. As with the above, this may be appropriately limited so as to capture the desired pool of accessory product sales, such as only those pertaining to home theater. At step 33, the sum of the retail prices of each accessory product sold is calculated. At step 34, the average selling price is calculated by dividing the sum determined in step 33 by the total number of accessory product sales in the set determined in step 32. The average selling price metric is useful as an indicator of the kinds of accessory products that a seller is attaching—whether they are low priced or higher priced.

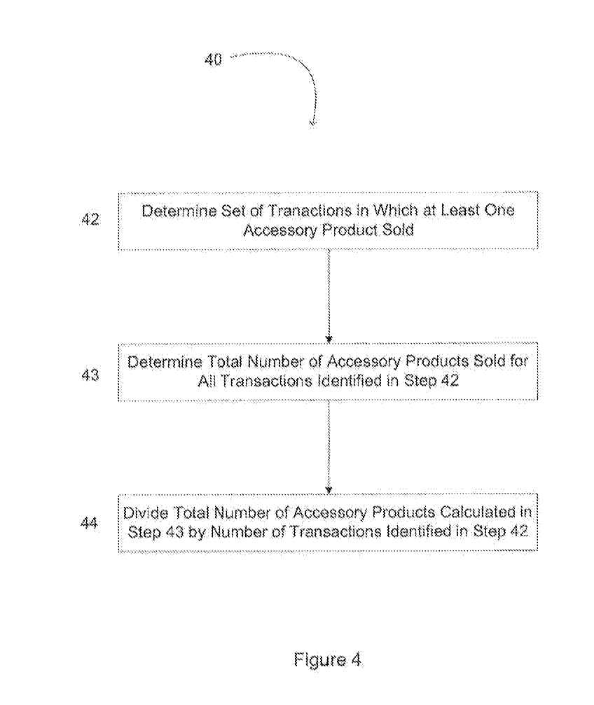

Finally, the calculation go step 40 of FIG. 1, items per ticket, is shown in FIG. 4. At step 42, the set of transactions in which at least one accessory product was sold is identified. As with the foregoing, this may be appropriately limited as desired. At step 43, the total number of accessory products sold in all transactions in the set determined in step 42 is calculated. At step 44, the items per ticket is calculated by dividing the number calculated in step 43 by the number of transactions in the set determined in step 42. The items per ticket metric is useful as a gauge of the quantity of accessory products a seller is able to attach to a sales transaction.

FIGS. 5-8 depict examples of the graphical representations which may be displayed to the user, but they are by no means exhaustive. The representations may be transformed (e.g., rotated, zoomed, translated), colored, shaded, textured, overlaid, combined, or otherwise manipulated to perform comparisons, spot trends, etc.

In an embodiment of the present invention, the foregoing measurements can be visually depicted by plotting a three-dimensional graph, as shown in FIG. 5. The axes represent attachment rate, average selling price, and items per ticket; and the overall performance score is represented by the volume of a cube having the dimensions of each measurement. This graphical depiction of the invention provides a striking visual presentation of the key measurements and how they combine to yield overall performance. The goal of the seller is to increase each of the key measurements, which can be visualized as expansion of the cube in each of its dimensions. Hence, the aforementioned metrics may be referred to as “cube metrics,” and the overall performance score resulting from the product of the cube metrics referred to as the “cube score.”

Those skilled in the art will readily appreciate the numerous advantages that inhere in the present invention. For rather than focusing on measures of revenue and sales volume, the present invention is drawn to metrics that aid one in evaluating efficiency. From the accessory product manufacturer's perspective, the present invention thereby provides a more accurate way to evaluate the performance of its dealers.

A larger dealer by virtue of its size and volume of merchandise will naturally yield larger revenues and sales volumes than a smaller dealer. However, merely examining revenue and sales volume does not inform the manufacturer as to a particular dealer's sales efficiency given the opportunities it encounters. But wider the system and method of the present invention, the size of the dealer is irrelevant. Instead, the metrics are directed to evaluating the efficiency with which the dealer capitalizes opportunities to sell accessory products.

The present invention provides an overall performance score, which provides an at-a-glance single numerical measure of seller performance. This is especially useful when comparing one seller to another, because focusing on any one metric would not capture a complete picture of the sellers' performance. Also, there may tend to be inverse relationships amongst the various metrics e.g. attachment rate may tend to decrease as average selling price increases. Therefore, having a single overall performance score accounts for these differences and allows one to accurately compare the sellers' relative performance.

The present invention also provides the ability to drill down into the components that make up the overall performance measurement. This is especially useful for tailoring a program for improvement of an individual seller's sales performance. For example, dealers X and Y may have the same overall performance score, but for different reasons. Dealer X may have a higher attachment rate than dealer Y, While dealer Y has a higher average sales price than dealer X. By drilling down into the component measurements, a manufacturer can more accurately evaluate each dealer and tailor its feedback to each one. In this case, the manufacturer would encourage and train dealer X specifically targeting the area of average sales price, whereas feedback and training for dealer Y would focus on improving the attachment rate.

Furthermore, the representation of the overall performance score as a cube having dimensions corresponding to each of the metrics provides an excellent tool for improving sales performance by virtue of its striking visual presentation. A large cube (as shown in FIG. 5) represents the ideal scenario, as this indicates that each of the metrics is being performed at a high level. Likewise, a deficiency in any of the metrics will result in a distorted or smaller cube, allowing one to easily spotlight areas that need improvement. A seller may thus be encouraged to grow the cube in all dimensions, but especially encouraged to target those areas resulting in distortion of the cube representation.

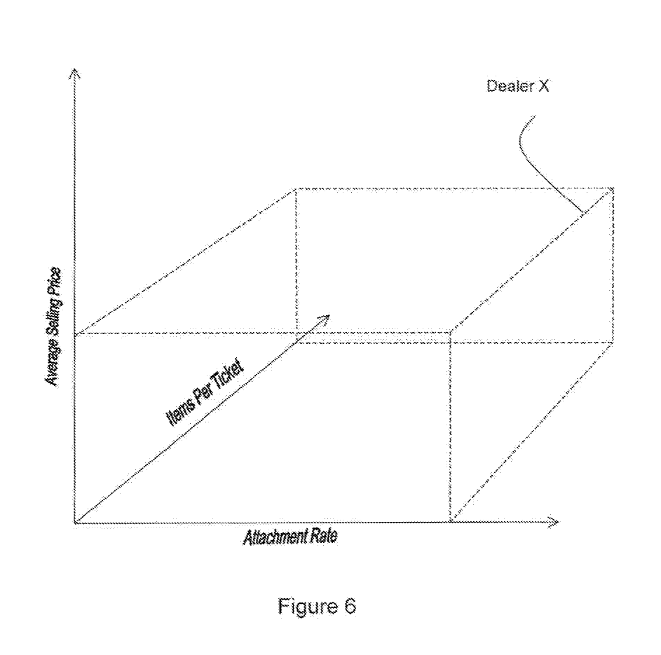

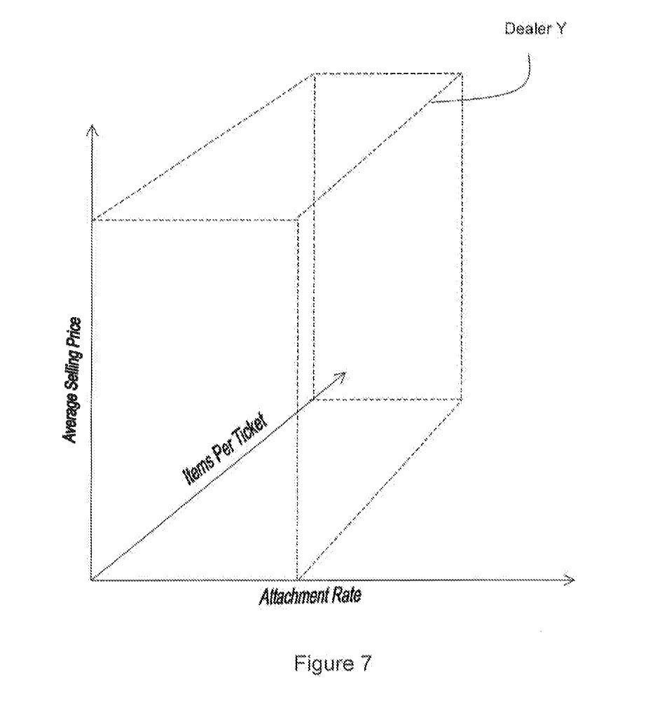

Reconsidering the aforementioned dealers X and Y, their cubes would appear distorted in accordance with the metric in Which they are underperforming. As shown in FIG. 6, dealer X′s cube is distorted due to low average sales price relative to the other metrics. And as shown in FIG. 7, dealer Y′s cube is distorted due to low attachment rate.

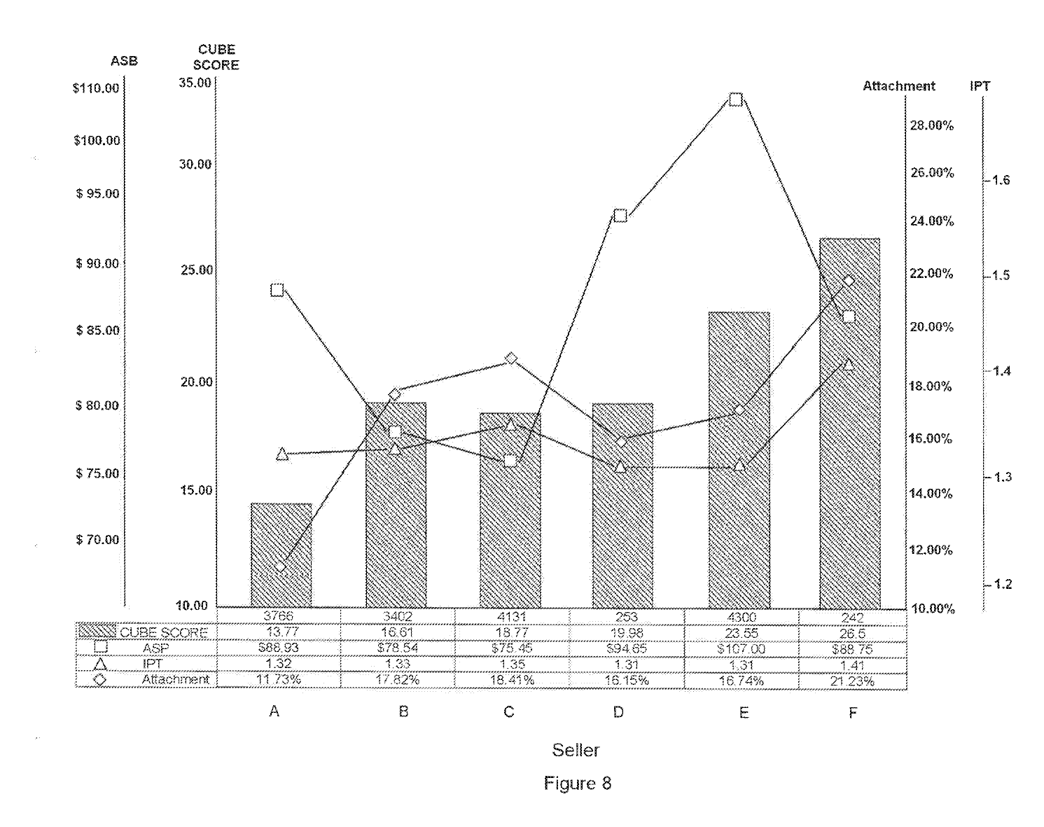

Obviously, the system and method of the present invention may be visualized according to any number of graphical methods that are well known in the art. These are contemplated within the scope of the present invention. One such example comprises a two-dimensional plot as shown in FIG. 8. In this instance, a bar chart is used to display the cube scores of various sellers. Simultaneously, the attachment rate, average selling price, and items per ticket metrics are overlaid on each seller's bar.

It will be appreciated that the system and methods of the present invention can be applied at all levels of the selling process from individual salespersons to manufacturers of accessory products and beyond. Managers can evaluate and provide targeted feedback to individual salespersons, just as a regional sales director can do the same for the stores within her region. The application of the present invention to all such selling scenarios is also contemplated within the scope of the present invention.

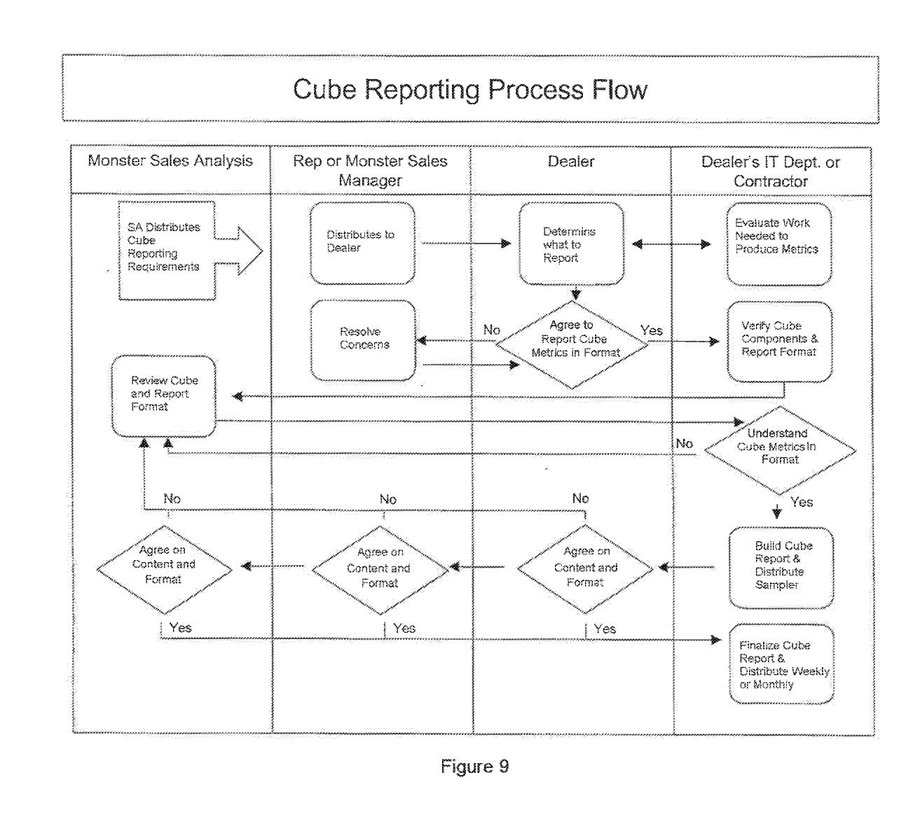

The method for implementing and reporting cube metrics amongst a manufacturer, its sales representatives, and dealers, according to the present invention, is shown in FIG. 9. First, the manufacturer's sales analysis group distributes reporting requirements to its representatives or sales managers. The representatives in turn distribute the reporting requirements to individual dealers. A given dealer works with its information technology (IT) department or contractor in evaluating the work needed to produce the appropriate metrics; and any concerns regarding reporting metrics are worked out between the dealer and sales representative until resolved, so that the dealer agrees to report the cube metrics in an acceptable format. The dealer's IT department then verifies the cube components and report format, which are sent to the manufacturer's sales analysis group for review. After review, if the cube metrics in format are understood by the dealer's IT department, then they proceed to build a cube report and distribute samples to the dealer, the manufacturer's representative, and the manufacturer's sales analysis group. If any of them is dissatisfied with the result, then further review by the manufacturer's sales analysis group is performed; and the process of understanding and building the report by the dealer's IT department is repeated. When all three groups (manufacturer's sales analysis group, representatives, dealer) agree on the content and format of the cube report, then the cube report is finalized and distributed on a weekly or monthly basis.

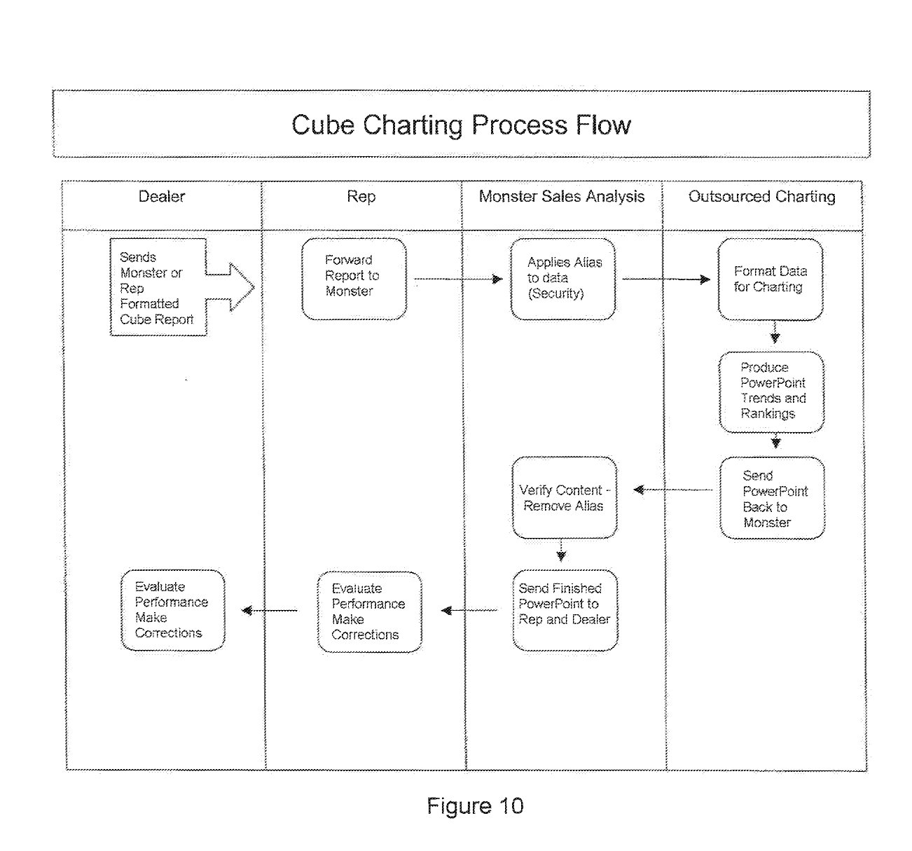

The method for charting the cube report, according to the present invention, is shown in FIG. 10. First, a dealer produces a formatted cube report and sends it to a manufacturer's representative, who then forwards the report to the manufacturer's sales analysis group. The sales analysis group applies an alias to the data for security purposes so that the identity of the originating dealer is unknown, and then forwards the data to an outsourced charting agency. The charting agency formats the data for charting, produces trends and rankings, and formats these in a presentation format such as a series of slides in PowerPoint. This presentation is sent back to the sales analysis group, which verifies the content, and removes the alias. The presentation is then forwarded to the manufacturer's representative, who evaluates performance and makes appropriate corrections. The report is then forwarded to the dealer, who also evaluates performance and makes appropriate corrections.

The embodiments described herein are presented by way of illustration only, and are not intended to limit the scope of the present invention in any manner. Indeed, additional modifications and further embodiments will become apparent upon study of the present disclosure, and these are contemplated within the scope of the present invention.

### INDUSTRIAL APPLICABILITY

The present invention industrially relates to a method and apparatus for evaluating the performance a seller of accessory products and can be used to help maximize that performance via an easy to understand cube-like representation.

What is claimed is;

1. A method for calculating and depicting the shape of a three-dimensional graphical representation of the sales performance data, the method comprising the following steps:
a. gathering sales data necessary to compute:
i. an attachment rate, the attachment rate being the proportion of qualifying sales transactions in which at least one accessory product was sold in the same transaction, the qualifying sales transactions including those sales transactions in which a primary product was sold for which a relevant accessory product could have been sold in conjunction therewith;
ii. an average selling price, the average selling, price being the average of the retail price of all accessory products sold; and
iii. items per transaction, the items per transaction being the average number of accessory products sold in a transaction in which at least one accessory product was sold with a primary product;
b. inputting the sales data into a computing apparatus configured to:
i. calculate the attachment rate, the average selling price, and the items per transaction into a computing apparatus;
ii. calculate the product of the attachment rate, the average selling price, and the items per transaction, to yield an overall performance score;
iii. create a graphical representation of a three-dimensional structure having three axes, each axis having a dimension, with the scale of each dimension corresponding to the attachment rate, the average selling price, and the items per transaction, respectively; and
iv. display to a user the graphical representation of the three-dimensional structure via a display means.

2. The method according to claim 1, wherein:
a. the first, second, and third axes of the graphical representation of the three-dimensional structure intersect at an origin;
b. the three-dimensional structure is a box-like structure where each of its edges is parallel to exactly one axis; and
c. the relative length of the pairs of parallel edges are proportionate to the attachment rate, the average selling price, and the items per transaction, respectively, of a seller whose performance is being measured.

3. The method according to claim 1, wherein displaying to the user the graphical representation of the three-dimensional structure further comprises displaying a report comprising the graphical representation of the three-dimensional structure.

4. A method for calculating and depicting the shape of a three-dimensional graphical representation of the sales performance data, the method comprising the following steps:
a. gathering sales data necessary to compute:
i. an attachment rate, the attachment rate being the proportion of qualifying sales transactions in which at least one accessory product was sold in the same transaction, the qualifying sales transactions including those sales transactions in which a primary product was sold for which a relevant accessory product could have been sold in conjunction therewith;
ii. an average selling price, the average selling price being the average of the retail price of all accessory products sold; and
iii. items per transaction, the items per transaction being the average number of accessory products sold in a transaction in which at least one accessory product was sold with a primary product;
b. inputting the sales data into a computing apparatus configured to:
i. calculate the attachment rate, the average selling price, and the items per transaction into a computing apparatus;
ii. calculate the product of the attachment rate, the average selling price, and the items per transaction, to yield an overall performance score;
iii. create a graphical representation of a three-dimensional structure having three axes, each axis having a dimension, with the scale of each dimension corresponding to the attachment rate, the average selling price, and the items per transaction, respectively; and
iv. report to a user the graphical representation of the three-dimensional structure via a reporting means.

5. The method according to claim 4, wherein:
a. the first, second, and third axes of the graphical representation of the three-dimensional structure intersect at an origin;
b. the three-dimensional structure is a box-like structure where each of its edges is parallel to exactly one axis; and
c. the relative length of the pairs of parallel edges are proportionate to the attachment rate, the average selling price, and the items per transaction, respectively, of a seller whose performance is being measured.

6. The method according to claim 4, wherein the reporting means comprises generating and transmitting a physical document comprising the graphical representation of the three-dimensional structure.

7. The method according to claim 4, wherein the reporting means further comprises generating and transmitting an electronic document comprising the graphical representation of the three-dimensional structure.
